(19) United States
(12) Patent Application Publication
(10) Pub. No.: US 2023/0183054 A1
(43) Pub. Date: Jun. 15, 2023

(54) DISPENSER FOR THE DELIVERY OF BEVERAGES AND RELATED DELIVERY METHOD

(71) Applicant: GENERAL BEVERAGE S.R.L., Milano (IT)

(72) Inventors: Giovan Battista VAROLI, Milano (IT); Cesare VAROLI, Milano (IT)

(73) Assignee: GENERAL BEVERAGE S.R.L., Milano (IT)

(21) Appl. No.: 17/923,682

(22) PCT Filed: May 10, 2021
(86) PCT No.: PCT/IB2021/053955

§ 371 Date: Nov. 7, 2022

(30) Foreign Application Priority Data
May 12, 2020 (IT) 102020000010798

(51) Int. Cl. B67D 1/08; B67D 1/00

(52) U.S. Cl. CPC B67D 1/0888; B67D 1/0081; B67D 2001/0087

(57) ABSTRACT

A dispenser for the delivery of beverages having at least a contactless acquisition element arranged according to well-defined positions so as not to be reached by any splashes during the delivery of the beverage.

### TECHNICAL FIELD

The present invention relates to a dispenser for the delivery of beverages, in particular to an automatic or semi-automatic dispenser for the delivery of beverages and water wherein the selection is made without any contact by the user interacting with the dispenser.

### BACKGROUND ART

The use of contactless technology for the delivery of products in general has long been known.

In the field of hygienic appliances, e.g., there are many solutions in which the water supply from the taps is activated by means of an optical sensor connected to an electronic circuitry that controls the opening/closing of a solenoid valve as a result of the recognition of the presence of a user’s hand. The activation of the solenoid valve makes it possible to regulate the quantity of water to avoid, for example, waste or damage due to the continuous movement of the mechanical components.

Similar solutions have also been implemented, e.g., for the automatic delivery of soaps, again through automatic recognition of the presence of the user’s hand. The control electronics in the known solutions described above are relatively simple to implement with the possibility of using optical components also inexpensive as it a high sensitivity of recognition is not necessary; it is sufficient, in fact, to capture a minimum variation in light intensity to activate the delivery, usually by placing the back of the hand in front of the optical sensor.

The need to avoid contact with activation surfaces, such as displays or the like, is becoming increasingly important also in all public places intended for the installation of beverage dispensers and shared by many users.

Generally, the selection of a beverage is made by means of a classic push-button panel which must necessarily be pressed with a finger by a user, most of the times previously touched numerous times by other users.

Think, for example, in the case of canteens or workplaces where dispensers are used tens if not hundreds of times a day. When users interact with these push-button panels, there is the risk of depositing contaminants on the surfaces that can be transferred to other users, thus causing potential transmission of pathologies, even dangerous.

At the time of the present disclosure, strict regulations have been introduced on the use of dispensers that require thorough sanitization and disinfection operations as a result of the rapid spread of the Covid-19 pandemic. In the perception of users, however, these regulations are almost useless due to the fear of potential contamination regardless of sanitation. As a result, the use and consumption of beverages is severely affected with consequent economic drawbacks for both producers and operators.

The Applicant, already active in the production of dispensers for the delivery of beverages, thought of a solution that would allow users to continue to interact with the beverage dispensers in absolute safety and without necessarily having to touch any part of the dispenser to choose and deliver the beverage.

The Applicant realized, however, that the simple automated recognition and delivery solutions used in the prior art are ill-suited in contexts where users interact with appliances capable of dispensing multiple products. Generally, in fact, a beverage dispenser may supply dozens of products with different options for ingredient combination and selection.

In this context, WO 03/042612 describes a beverage dispenser having several contactless sensors positioned inferiorly to the respective nozzles. In order to deliver a particular beverage, the user places a glass in front of the sensor to activate the delivery thereof. The activation of a sensor allows the beverage to be delivered only from the nearest top nozzle. A drawback of having the sensors positioned under the delivery nozzle is that, in the long run, the sensors themselves can become dirty due to the splashes produced by the delivery of the beverages themselves, especially for dispensers configured to deliver numerous beverages, which results in possible malfunctions or errors.

### DESCRIPTION OF THE INVENTION

By virtue of the needs listed above, the Applicant has developed a beverage dispenser provided with contactless acquisition elements arranged according to well-defined positions so as not to be reached by any splashes during the delivery of the beverage and at the same time able to activate the selection of a beverage safely and in an extremely simplified and intuitive manner both in the case of interaction by adults and by children and/or people with disabilities.

Thus, one object of the present invention relates to a dispenser for the delivery of beverages according to claim 1.

Another object of the present invention relates to a method for the delivery of beverages according to claim 15.

### BRIEF DESCRIPTION OF THE DRAWINGS

Further characteristics and advantages of the dispenser and of the method for the delivery of beverages according to the present invention will result from the description below of preferred embodiments thereof, given by way of an indicative yet non-limiting example, with reference to the attached figures, wherein:

FIG. 1 represents a perspective view of a dispenser for the delivery of beverages according to the present invention,

FIG. 2 represents a front view of the distributor in FIG. 1,

FIG. 3 represents a schematic side view of the placement of a finger of a user’s hand in front of the contactless acquisition elements of the dispenser in FIG. 1,

FIG. 4 represents a schematic side view of a user picking up a beverage from the dispenser of FIG. 1 according to a first possible use,

FIG. 5 represents a schematic side view of a user picking up a beverage from the dispenser of FIG. 1 according to an alternative use.

### EMBODIMENTS OF THE INVENTION

With reference to the attached figures, reference numeral 1 globally indicates a dispenser for the delivery of beverages according to the present invention.

In the remainder of the present description and in the subsequent claims, by “dispenser for beverages” is meant an appliance intended for the delivery of liquids that are drunk to quench one’s thirst, such as, e.g., mixtures, juices, soft drinks, infusions, water and combinations thereof. Additionally, the dispenser 1 may be of the automatic or semi-automatic type. By “Automatic” is meant an appliance capable of having various fully automated functions such as, e.g., glass supply, payment interface, etc. On the other hand, a “semi-automatic” dispenser is usually fitted in a self-service environment in which the appliance does not provide payment interfaces and does not supply the glass (the user receives the beverage on his own glass or a glass previously taken on appropriate dispensers). Different embodiments cannot however be ruled out wherein the dispenser 1 according to the invention may be of a combined type and comprise both automatic and semi-automatic functions.

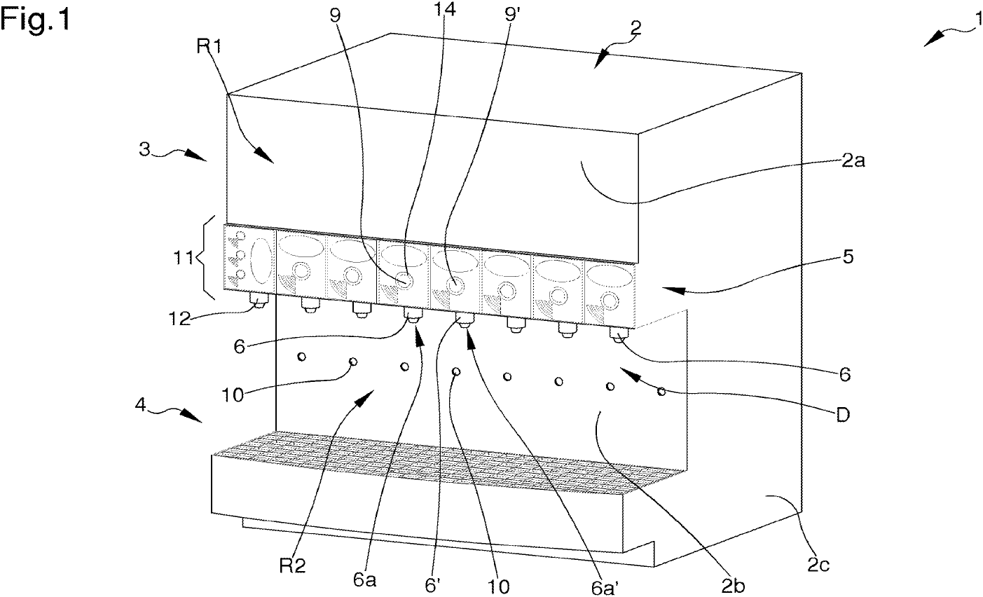

As shown in the example of FIG. 1, the dispenser 1 is provided with a frame 2 resting on a supporting surface and defining a volume adapted to house a plurality of components known per se to be both internal and partly external and necessary for its operation. In detail, the dispenser 1 comprises a hydraulic circuitry wherein a first inlet connectable to an external water network for water inlet and a second inlet connectable to one or more containers (so-called “bag-in-box”) of the concentrates for the preparation of beverages are identified.

The components intended for the operation of the dispenser 1 may comprise, e.g., mixing means, water purification and filtration means, a cooling system, a compressor, a condenser, a positive displacement pump, a solenoid valve, etc., which are connected in a fluid-operated manner to each other according to substantially known techniques.

Preferably, the filtration means allow for the delivery of refrigerated natural micro-filtered water, room temperature natural micro-filtered water, and carbonated micro-filtered water, depending on the choice of the user. According to a preferred embodiment, in the frame 2 is identified an upper portion 3 intended for housing, even partly externally, the components required to the interface with the user and a lower portion 4.

According to some embodiments, the containers of the bag-in-box concentrates for the preparation of the beverages may be housed inside the frame 2 or may also be contained in compartments which are separate from the dispenser 1, e.g., inside a supporting trolley for the frame 2 and provided with wheels to be easily moved. After the product inside the containers is finished, the latter are replaced with new containers and connected to the distributor’s hydraulic circuit.

Advantageously, the dispenser 1 is a compact appliance with low electrical consumption, e.g., less than 3 kW, preferably about 1 kW. The frame 2 has a height of between 500 and 1000 mm, preferably 780 mm, a width of between 250 and 750 mm, preferably 500 mm, and a depth of between 500 and 1000 mm preferably 740 mm. In this way it is possible to ensure simple and fast installations directly inside catering centers, canteens, offices, amusement parks, tourist villages, gyms, naval catering, etc.

In the context of the present disclosure, the terms “upper”, “lower”, “vertical” and “horizontal” and/or similar designations shall be understood to refer to the conditions of normal use of the dispenser, i.e., those in which it is used, in general, by a user for the delivery of one or more beverages for consumption.

Between the upper portion 3 and the lower portion 4 of the frame 2 is identified an intermediate delivery portion 5 comprising a nozzle set D having one or more nozzles 6 for the delivery of the beverage to be supplied, by pressure drop, into a user’s glass.

Preferably, the nozzle set D comprises at least a first nozzle 6.

According to an embodiment, the nozzle set D comprises a second nozzle 6′ positioned alongside the first nozzle 6. Conveniently, the cooling system (not shown) allows a beverage to be delivered at the outlet of each nozzle 6, 6′ at a preferred temperature between 2 and 6° C.

Preferably, the beverage exiting each nozzle 6, 6′ is a beverage obtained by mixing the ingredients contained in one or more bag-in-box containers by means of opening/closing of a respective solenoid valve according to known per se techniques.

According to a preferred embodiment, the nozzles 6, 6′ are arranged next to each other along a direction X1, in use, substantially horizontal and positioned on top of a collecting surface 7 of any liquid residue.

Conveniently, the nozzles 6, 6′ are horizontally separated from each other by a centre-to-centre distance between 30 mm and 100 mm, preferably 65 mm. Each nozzle 6, 6′ is oriented along its own substantially vertical direction Y1, Y1′ so that the opening 6a, 6a′ for the outflow of the beverage faces downwards, in particular towards the collecting surface 7.

Between the nozzles 6, 6′ and the collecting surface 7 is formed a seat 8 which is arranged to accommodate the user’s glass to be placed under each opening 6a, 6a′ of the respective nozzle 6, 6′ to receive the desired beverage.

Conveniently, the frame 2 is enclosed by a plurality of removable panels, preferably made of steel. In detail, the dispenser 1 mainly comprises at least one upper front panel 2a arranged at the upper portion 3, a lower front panel 2b arranged at the seat 8, two side panels 2c, and a rear panel.

The total number of nozzles 6, 6′ may vary between a minimum of one to a maximum of ten and even more in order to be able to optimally diversify the types of beverages that can be delivered and to respond to the different tastes of the users. It follows that, in a preferred embodiment, the nozzle set D may comprise a plurality of nozzles 6, 6′, the number of which is selected according to the amount of beverages to be delivered.

Advantageously, the dispenser 1 is provided with a first acquisition set R1 comprising at least a first contactless acquisition element 9 which is configured to intercept the presence or absence of a user’s finger.

The first acquisition set R1 is preferably positioned at the upper portion 3 of the frame 2.

Preferably, the first acquisition element 9 is positioned on top of the first nozzle 6. Different embodiments cannot however be ruled out wherein, e.g., the acquisition element 9 is positioned to the side of the nozzle 6, in close proximity to the latter.

The first acquisition set R1 comprises at least a second contactless acquisition element 9′ configured to intercept the presence or absence of a user’s finger entirely similar to the first acquisition element 9.

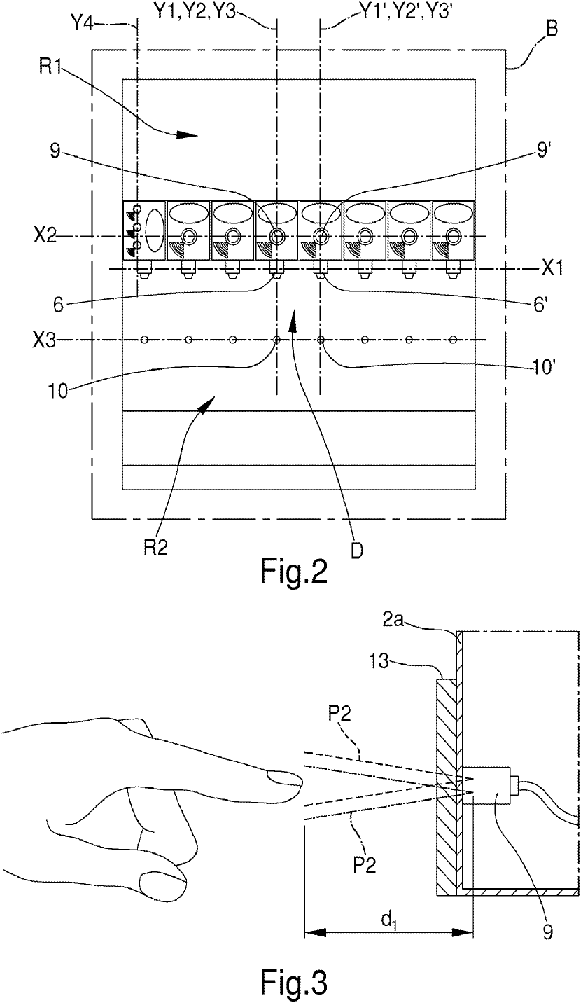

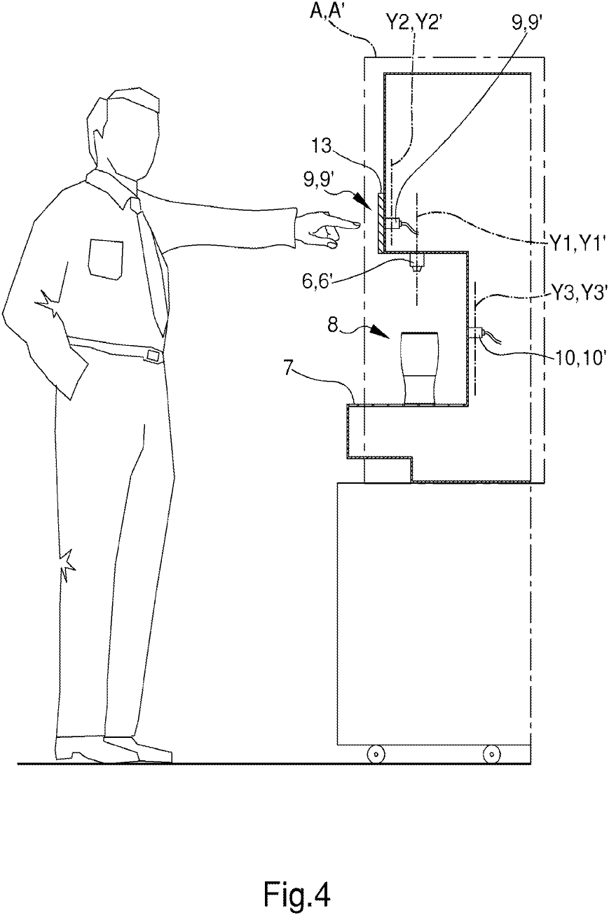

As observable in the examples of FIGS. 2 and 4, each acquisition element 9, 9′ is mounted on the frame 2 and arranged along its own substantially vertical direction Y2, Y2′ and parallel to the direction Y1, Y1′. In detail, the directions Y1, Y1′ and Y2, Y2′ of the nozzle 6, 6′ and of the acquisition element 9, 9′ respectively, are preferably contained in the same plane A, A′ extended transversely to the dispenser 1 in the direction of its width (FIG. 4).

According to one embodiment, the second acquisition element 9′ is positioned on top of the first nozzle 6 and to the side of the first acquisition element 9. Such an embodiment describes a dispenser wherein the number of nozzles is less than the number of acquisition elements. In this context, several acquisition elements are arranged on top of an individual nozzle 6 and juxtaposed with each other. As will be discussed below, several acquisition elements may be configured to deliver a beverage from an individual nozzle.

According to a further embodiment, the second acquisition element 9′ is positioned on top of the second nozzle 6′. In particular, the second acquisition element 9′ is positioned on top of the second nozzle 6′ along its own vertical direction Y2′ substantially parallel to the vertical direction Y1′. Conveniently, the directions Y1′, Y2′ are contained in a second plane A′ parallel to the first plane A and extending transversely to the dispenser 1. Such an embodiment describes a dispenser in which the number of acquisition elements is equal to the number of nozzles. In this context, each acquisition element is arranged on top of a respective individual nozzle 6. As will be seen below, each acquisition element is configured to deliver the beverage from the nearest underlying nozzle.

Conveniently, the acquisition elements 9, 9′ are horizontally separated from each other by a centre-to-centre distance between 30 mm and 100 mm, preferably 65 mm.

The acquisition elements 9, 9′ are arranged one next to the other along a direction X2 parallel to the horizontal direction X1 and positioned overall in a plane B (FIG. 2) substantially parallel to the upper front panel 2a.

Conveniently, the acquisition elements 9, 9′ are preferably located further forward with respect to the nozzles 6, 6′ (with respect to the observation point of a user located in front of the dispenser).

Advantageously, the acquisition elements 9, 9′ are at least equal in number as the nozzles 6, 6′. In the examples shown, the dispenser 1 comprises seven acquisition elements and seven nozzles wherein each acquisition element 9, 9′ is positioned on top of each nozzle 6, 6′ at a distance from the latter of preferably 30 to 90 mm, preferably 60 mm.

As will be seen later, the close arrangement between the acquisition element 9, 9′ and the respective nozzle 6, 6′ allows the user’s attention to be focused on the position of the finger at the beverage to be selected, thus decreasing the risk of accidental contacts with the dispenser and increasing the overall safety of interaction with the dispenser.

According to a preferred embodiment, each acquisition element 9, 9′ is composed of an optical proximity sensor of the combined emitter/receiver type configured to emit and receive a light radiation along substantially coincident emission/receiving optical paths P1, P2.

Conveniently, the emitter of the acquisition element 9, 9′ is configured to emit a preferably infrared light radiation, while the receiver is configured to intercept the presence of an object in a preset range between 0 mm and 100 mm. Substantially, the acquisition element 9, 9′ can be activated by a finger of a user when positioned at a preset distance d1 between 0 mm and 100 mm, preferably 35 mm with respect to the acquisition element 9, 9′ itself. This means that, in fact, the acquisition element 9, 9′ can be activated either contactless (distance from the sensor > 0 mm), or with contact (distance from the sensor about 0 mm).

The acquisition elements 9, 9′ are juxtaposed to each other along a horizontal direction X2 and positioned overall in a plane B substantially parallel to the upper front panel 2a for the closure of the frame 2.

The emission/receiving optical paths P1, P2 extend substantially perpendicularly with respect to said plane B, in front of the dispenser 1. According to an embodiment, the emission/receiving optical paths P1, P2 may also be oriented along an upwardly or downwardly inclined direction to facilitate the activation of the acquisition elements 9, 9′ also by children or short persons.

Conveniently, the emitter and the receiver of each acquisition element 9, 9′ are mounted on am individual support having at least two openings, spaced a few millimeters apart, for the passage of the illumination and acquisition cones of the optical paths P1, P2, respectively. Preferably, each cone of the individual optical paths P1, P2 has an opening angle between 15° and 40°, preferably 25°. The choice of such opening angles makes it possible to avoid interception errors of the user’s finger even in the case of elements 9 positioned very close together. Advantageously, an angle greater than 25° can allow the activation of the acquisition elements also by means of several fingers close together or with other parts of the hand, e.g. the palm or the back.

According to one embodiment, each acquisition element 9, 9′ may also comprise an ambient light sensor for the calibration and settings of the threshold values depending on the intended use of the dispenser.

The acquisition elements 9, 9′ are in signal communication with a control unit that commands the opening/closing of the nozzles 6, 6′ to deliver the beverage depending on the generation of a trigger signal from a predetermined acquisition element 9, 9′.

According to one embodiment, in the event of the number of acquisition elements being greater than the number of nozzles, the control unit is configured to have the beverage delivered from a first nozzle 6 if any of the above acquisition elements is activated by a user’s finger.

According to a further embodiment, the control unit is programmed to have the beverage delivered from a predetermined nozzle 6, 6′, if and only if the nearest acquisition element 9, 9′ to said nozzle 6, 6′ is activated by a user’s finger. Such a configuration is convenient, for example, when the dispenser has a number of acquisition elements equal to the number of nozzles. It follows that, if a user wishes to receive the beverage from the rightmost nozzle (with reference to the observation point of a user placed in front of the dispenser), they will bring the finger of one hand close to the rightmost sensor and with the other hand will place the glass just under the rightmost nozzle. Similar operations also apply to all other positions.

It may happen, however, that a user mistakenly places the glass under any other nozzle 6 but moves the finger closer to the sensor 9 not closer to that nozzle. In such a case, the dispenser 1 may have checking means for preventing accidental outflow of a beverage from a nozzle under which the user has not placed the glass. For this purpose, the dispenser 1 may comprise a plurality of auxiliary acquisition elements 10, 10′ that are entirely similar to the acquisition elements 9, 9′ to prevent the beverage from being delivered.

In detail, the auxiliary acquisition elements 10, 10′ are configured to generate a trigger signal when the user’s glass is positioned in front of a respective element 10, 10′.

The auxiliary acquisition elements 10, 10′ are preferably positioned below the nozzles 6, 6′ at the seat 8 arranged to accommodate the user’s glass.

The auxiliary acquisition elements 10, 10′ are arranged next to each other along a direction X3 parallel to the horizontal direction X1 and positioned overall in a plane B substantially parallel to the lower front panel 2b.

The control unit is also configured to set the delivery activation times from the instant when the finger is intercepted by the acquisition element. Preferably, the range between the instant when the user’s finger is intercepted and the instant when the beverage is delivered is between 0.01 seconds and 0.50 seconds, preferably 0.09 seconds.

In the combined version with double acquisition element 9, 9′ and 10, 10′, the control unit first acquires the trigger signal from the acquisition element 9, 9′ and checks whether the auxiliary acquisition element 10, 10′ has also generated its own trigger signal. If and only if both trigger signals are received by the checking means from the control unit, the latter activates the corresponding nozzle 6, 6′. Otherwise, the beverage is not delivered. In this case, an audio/visual message can be provided to inform the user that the glass has not been placed under the correct nozzle 6, 6′.

Advantageously, the selection of the auxiliary acquisition elements 10, 10′ can also be done by means of the proximity sensors with opening cones which are more open than the main acquisition elements 9, 9′ since high sensitivity is not required for activation by means of the glass.

Conveniently, the electronic control unit is configured to have the delivery of the beverage continue from a respective nozzle 6, 6′ as long as the user’s finger remains positioned frontally to the respective sensor 9, 9′, in particular in the opening cone P1, P2 of the emission/receiving optical path of a respective acquisition element 9, 9′ and/or 10, 10′.

According to further embodiments, the acquisition elements 9, 9′ may also be positioned in the upper portion 3 of the frame 2 also according to different orientations and distributed not necessarily along one and the same direction. For example, as can be observed in FIG. 1, secondary acquisition elements 11 oriented overall along a vertical (rather than horizontal) direction can be arranged alongside the main group of the acquisition elements 9, 9′. In detail, the secondary acquisition elements 11 may be used to activate the delivery of different types of beverage, e.g. unmixed, such as refrigerated natural micro-filtered water, room temperature natural micro-filtered water, and carbonated micro-filtered water.

Advantageously, the secondary acquisition elements 11 are greater in number than the nozzles. In the example shown, the dispenser 1 comprises three secondary acquisition elements 11 for the delivery of multiple unmixed beverages from an individual additional nozzle 12. In particular, the secondary acquisition elements 11 are positioned one on top of the other above the additional nozzle 12. Preferably, the three elements 11 allow delivering, from above, refrigerated natural micro-filtered water, room temperature natural micro-filtered water, and carbonated micro-filtered water, respectively.

In detail, each secondary acquisition element 11 is arranged along its own direction Y4 substantially vertical and parallel to the direction Y1 and Y2. Conveniently, the secondary acquisition elements 11 are vertically separated from each other by a centre-to-centre distance between 10 mm and 50 mm, preferably 25 mm.

According to some versions, the dispenser 1 may be provided with one or more covers 13 to partly or completely cover the front panel 3 of the frame 2 and of the acquisition elements 9. The cover 13 contains graphic elements intended to indicate the types of beverage that can be delivered and other communication messages customized according to the intended use of the dispenser 1. Conveniently, the cover 13 may be made of an at least partly transparent material so as to be backlit by lighting means arranged in the front panel 3. The cover 13 may be perforated at each acquisition element 9 for the passage of the optical paths P1, P2.

According to one embodiment, the dispenser may comprise acoustic and/or visual signaling means to inform the user that a certain beverage is ready to be delivered and that the beverage is being delivered. Preferably, as shown in the example of FIG. 1, the signaling means may comprise light indicators 14 arranged around each acquisition element for the purpose of providing light color variations according to the delivery status of the beverage. By way of example, prior to the delivery, the light indicator 14 may emit red light to inform the user when no dispenser is operating and green light thereafter upon activation of the selected acquisition element and as long as the user’s finger is positioned in front of the respective sensor, in the opening cone of the emission/receiving optical paths P1, P2.

Similarly, the signaling means may comprise acoustic indicators (not shown) for the purpose of providing acoustic signals that are also variable depending on the delivery status of the beverage.

According to an embodiment not shown, the dispenser 1 may comprise one or more level sensors to measure the amount of beverage which is contained in a user’s glass. In this context, the control unit is intended to stop the delivery when the liquid in the glass exceeds a preset limit, for example close to reaching the brim thereof. Preferably, the same secondary acquisition elements 11 may detect both the presence of the glass and the level of liquid in the glass, for example, by providing users with at least partly transparent glasses.

As mentioned above, the dispenser is configured to deliver mixed beverages and/or unmixed beverages. To this end, the hydraulic circuitry is connected to the external water network for water inlet and is intended to be in fluidic communication with the first nozzle 6 and/or with the second nozzle 6′. In one version, the hydraulic circuitry is connected to the external water network for water inlet and is intended to be in fluidic communication with the first nozzle 6, the second nozzle 6′ and/or the additional nozzle 12.

The dispenser may comprise at least a first container of concentrated ingredients in fluidic communication with the first nozzle 6 and/or the second nozzle 6′. In one embodiment, the dispenser comprises at least a second container of concentrated ingredients in fluidic communication with the first nozzle 6 and/or the second nozzle 6′.

In a preferred version, the hydraulic circuitry, the nozzles 6, 6′, 12 and the first and second containers are in fluidic communication with each other.

In a further embodiment, the hydraulic circuitry, the first nozzle 6 and/or the second nozzle 6′ and the first and/or second containers are in fluidic communication with each other for the delivery of mixed beverages.

In a further version, the hydraulic circuitry and the additional nozzle 12 are in fluidic communication with each other for the delivery of unmixed beverages. It is apparent that the first nozzle 6 and/or the second nozzle 6′ may also be configured for the delivery of unmixed beverages.

One of the possible methods for the delivery of a beverage according to the present invention is described below.

An initial phase involves a user standing in front of the dispenser 1 and placing the finger of one hand near one of the acquisition elements 9, 9′ and with the other hand placing the glass under the nozzle 6, 6′ closest to that acquisition element 9 (FIG. 4).

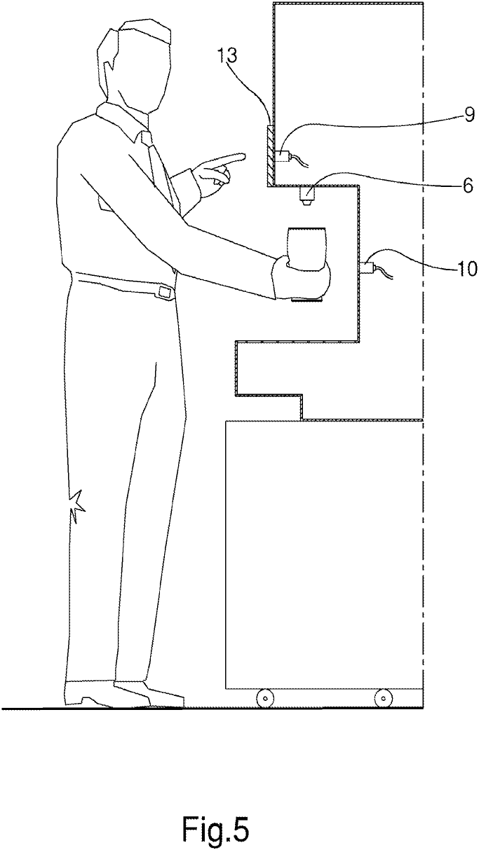

Optionally, the user can previously place the glass on the surface 7 and start the delivery of the beverage by approaching the finger of one hand only without having the other hand engaged (FIG. 5).

Subsequently, the electronic control unit receives the trigger signal from the acquisition element 9, 9′ indicated by the user in order to activate the delivery and therefore the opening of the respective delivery nozzle 6, 6′ by, for example, opening/closing a respective solenoid valve associated therewith.

The delivery of the beverage may end when:
the user moves the finger away from the acquisition element 9, 9′ beyond the predefined preset range,
the user’s finger exits the optical paths of the activated acquisition element 9, 9′,
the user’s glass exits the optical paths of the auxiliary acquisition element 10, 10′,
the liquid in the glass exceeds a preset limit.

In the event that a user places the glass under the nozzle 6 no longer closer to the indicated acquisition element 9, the electronic control unit will not deliver any beverage.

According to a further embodiment, the user may also activate the delivery by merely bringing the glass closer to one of the auxiliary acquisition elements 10. Still according to a further embodiment, the user may activate the delivery of unmixed beverages, e.g. water, by activating one of the secondary acquisition elements 11 according to techniques completely similar to those described above with reference to the main acquisition elements 9.

According to a further embodiment, if the dispenser has a number of nozzles less than the number of acquisition elements (e.g., one nozzle 6 and two acquisition elements 9, 9′, the delivery of a beverage may occur indistinctly by activating any one of the two acquisition elements 9, 9′.

As could be appreciated from what has been described, the dispenser for the delivery of beverages according to the present invention makes it possible to meet the requirements and overcome the drawbacks referred to in the introductory part of the present description with reference to the prior art.

Obviously, the embodiments and versions described and illustrated hereinabove are to be considered purely for illustrative purposes, and a person skilled in the art may, in order to meet contingent and specific requirements, make numerous modifications and variations to the system according to the above-described invention, comprising, for example, the combination of said embodiments and versions, all of which, however, are contained within the scope of protection of the invention as defined by the following claims.

1) A dispenser for the delivery of beverages, the dispensercomprising:
a frame provided with an upper portion intended for the interface with a user and with an intermediate portion comprising a nozzle set having at least a first nozzle intended for the delivery of a beverage to be supplied into a user’s glass and positioned below said upper portion; and
a first acquisition set comprising a first contactless acquisition element which can be activated by means of a user’s finger and configured for the opening/closing of said nozzle as a result of the wherein activation of said first acquisition element, wherein
said first contactless acquisition element is positioned on top of said first nozzle.

2) The dispenser according to claim 1, wherein said first nozzle is provided with its own opening for the outflow of the beverage and is oriented overall along a first substantially vertical direction, and
said first acquisition element is positioned along its own direction substantially parallel to said first vertical direction, said directions being contained in a first plane extended substantially transversely to the dispenser.

3) The dispenser according to claim 1,wherein said first acquisition set comprises a second acquisition element positioned on top of said first nozzle and to the side of said first acquisition element.

4) The dispenser according to claim 1, wherein said nozzle set comprises a second nozzle positioned to the side of said first nozzle and provided with its own opening for the outflow of an additional beverage, said second nozzle being oriented overall along a second substantially vertical direction .

5) The dispenser according to , claim 3, wherein said second acquisition element is positioned on top of said second nozzle along its own direction substantially parallel to said vertical direction, said directions being contained in a second plane extended transversely to the dispenser and parallel to the first plane.

6) The dispenser according to wherein said acquisition elements are arranged one next to the other along a horizontal direction and positioned overall in a plane substantially parallel to the upper portion of said frame.

7) The dispenser according to claim 4, wherein said nozzles are arranged one next to the other along a horizontal direction and positioned overall in a plane substantially parallel to the upper portion of said frame.

8) The dispenser according to claim 1, wherein said first acquisition set is located further forward with respect to the nozzle set.

9) The dispenser according to claim 1, wherein each acquisition element can be activated by a finger of a user when positioned at a distance between 0 mm and 100 mm to the respective acquisition element.

10) The dispenser according to claim 1, further comprising: a control unit in signal communication with said plurality of acquisition elements which is configured to control the opening/closing of the nozzles depending on the generation of a trigger signal of a predetermined acquisition element , said control unit being programmed to deliver the beverage from a predetermined nozzle only if, the acquisition element closest to this nozzle is activated by a user’s finger.

11) The dispener according to The dispenser claim 3, farther comprising: a control unit in signal communication with said plurality of acquisition elements which is configured to control the opening/closing of the nozzles depending on the generation of a trigger signal of a predetermined acquisition element , said control unit being programmed to deliver the beverage from said first nozzle if either the first or the second acquisition element is activated by a user’s finger.

12) The dispenser according to claim 1, further comprising: a hydraulic circuitry in fluidic communication with an external water network for water inlet and in fluidic communication with said first nozzle and/or said second nozzle .

13) The dispenser according to claim 1, further comprising: at least a first container of concentrated ingredients in fluidic communication with said first nozzle and/or said second nozzle .

14) The dispenser according to claim 1, further comprising: at least a second container of concentrated ingredients in fluidic communication with said first nozzle and/or said second nozzle.

15) A method for the dispensing of a beverage, said method comprising the phases of:
having said dispenser according to claim 1,
providing for a user to position him/herself in front of said dispenser and to approach the finger of a hand to at least one acquisition element , and
activating the delivery of a beverage from said nozzle.

16) The dispenser according to claim 4, wherein said second acquisition element is positioned on top of said second nozzle along its own direction substantially parallel to said vertical direction, said directions being contained in a second plane extended transversely to the dispenser and parallel to the first plane.

17) The dispenser according to claim 4, wherein said acquisition elements are arranged one next to the other along a horizontal direction and positioned overall in a plane substantially parallel to the upper portion of said frame.

18) The dispenser according to claim 16, wherein said acquisition elements are arranged one next to the other along a horizontal direction and positioned overall in a plane substantially parallel to the upper portion of said frame.

19. A dispenser for the delivery of beverages, the dispenser comprising:
a frame provided with an upper portion and with an intermediate portion comprising a nozzle set having at least a first nozzle positioned below said upper portion; and
a first acquisition set comprising a first contactless acquisition element configured to and/or programmed to sense movement, wherein said first acquisition set is configured for the opening/closing of said nozzle based on said movement sensed by said first acquisition element, wherein
said first contactless acquisition element is positioned on top of said first nozzle.

20. A method for the dispensing of a beverage, said method comprising:
having a dispenser wherein said dispenser includes a frame provided with an upper portion and with an intermediate portion comprising a nozzle set having at least a first nozzle positioned below said upper portion; and a first acquisition set comprising a first contactless acquisition element configured to and/or programmed to sense movement, wherein said first acquisition set is configured for the opening/closing of said nozzle based on said movement sensed by said first acquisition element, wherein said first contactless acquisition element is positioned on top of said first nozzle;
providing for a user to position him/herself in front of said dispenser and to approach a part of said user to at least one acquisition element; and
activating the delivery of a beverage from said nozzle.
